(19) United States
(12) Patent Application Publication
(10) Pub. No.: US 2025/0264595 A1
(43) Pub. Date: Aug. 21, 2025

(54) SLOPE SCRAMBLING FOR FREQUENCY-MODULATED CONTINUOUS WAVE (FMCW) BASED RF SENSING IN CELLULAR NETWORKS

(71) Applicant: QUALCOMM Incorporated, San Diego, CA (US)

(72) Inventors: Weimin DUAN, San Diego, CA (US); Kangqi LIU, San Diego, CA (US); Danlu ZHANG, San Diego, CA (US)

(21) Appl. No.: 18/582,443

(22) Filed: Feb. 20, 2024

(51) Int. Cl. G01S 13/34; G01S 13/58

(52) U.S. Cl. CPC G01S 13/343; G01S 13/584

(57) ABSTRACT

Frequency-modulated continuous wave (FMCW) slope scrambling for radio frequency (RF) sensing may be performed by a sensing node. The sensing node can receive a slope configuration from a configuring node of a wireless network, wherein the slope configuration includes one or more parameters indicative of a frequency slope value for each chirp of an FMCW transmission sequence to be used by the sensing node for RF sensing. The sensing node can further perform an RF sensing function in accordance with the slope configuration.

### BACKGROUND

### 1. Field of Disclosure

The present disclosure relates generally to the field of radio frequency (RF) sensing, and more specifically to RF sensing in a wireless network.

### 2. Description of Related Art

The performance of RF sensing by wireless devices can have a wide range of consumer, industrial, commercial, and other applications. RF sensing can be used to determine the presence of a target object, determine the location of the target object, and/or track the movement of the target object over time. Cellular networks (e.g., fifth-generation (5G) new radio (NR) networks) and other types of wireless networks may be capable of performing RF sensing using base stations, user equipments (UEs), and/or other wireless devices communicatively coupled with the cellular network as “sensing nodes.” To perform RF sensing, these sensing nodes can transmit and receive RF signals, including frequency-modulated continuous wave (FMCW) signals.

### BRIEF SUMMARY

An example method of frequency-modulated continuous wave (FMCW) slope scrambling at a sensing node for radio frequency (RF) sensing, according to this description, comprises: receiving a slope configuration at the sensing node from a configuring node of a wireless network, wherein the slope configuration includes one or more parameters indicative of a frequency slope value for each chirp of an FMCW transmission sequence to be used by the sensing node for RF sensing. The method further comprises performing an RF sensing function at the sensing node in accordance with the slope configuration.

An example method of providing a frequency-modulated continuous wave (FMCW) slope scrambling configuration for radio frequency (RF) sensing, according to this description, comprises: determining, with a configuring node of a wireless network, a slope configuration for a sensing node, wherein the slope configuration includes one or more parameters indicative of a frequency slope value for each chirp of a frequency-modulated continuous wave (FMCW) transmission sequence to be used by the sensing node for RF sensing. The method further comprises sending the slope configuration to the sensing node to enable the sensing node to perform an RF sensing function in accordance with the slope configuration.

An example sensing node, according to this description, comprises: one or more transceivers; one or more memories; and one or more processors communicatively coupled with the one or more transceivers and the one or more memories. The one or more processors are configured to receive a slope configuration via the one or more transceivers from a configuring node of a wireless network, wherein the slope configuration includes one or more parameters indicative of a frequency slope value for each chirp of a frequency-modulated continuous wave (FMCW)transmission sequence to be used by the sensing node for radio frequency (RF) sensing; and perform an RF sensing function in accordance with the slope configuration.

An example configuring node, according to this description, comprises: one or more transceivers; one or more memories; and one or more processors communicatively coupled with the one or more transceivers and the one or more memories. The one or more processors are configured to determine a slope configuration for a sensing node, wherein the slope configuration includes one or more parameters indicative of a frequency slope value for each chirp of a frequency-modulated continuous wave (FMCW) transmission sequence to be used by the sensing node for radio frequency (RF) sensing; and send the slope configuration via the one or more transceivers to the sensing node to enable the sensing node to perform an RF sensing function in accordance with the slope configuration.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a positioning/sensing system that can use the techniques provided herein for slope scrambling for frequency-modulated continuous wave (FMCW)-based radio frequency (RF) sensing, according to an embodiment.

FIG. 2 is a diagram of a fifth-generation (5G) new radio (NR) positioning/sensing system, according to an embodiment.

FIG. 3 is a diagram showing an example of an RF sensing system, according to an embodiment.

FIG. 4A is a diagram of the frequency of an example FMCW chirp, plotted over time.

FIG. 4B is a diagram illustrating how the analog processing of FMCW signals may be performed prior to digital conversion, according to an embodiment.

FIG. 5A is a simplified illustration of an example scenario in which FMCW signals may interfere with the detection of a target.

FIG. 5B illustrates a corresponding range-Doppler map at the victim sensing node of FIG. 5A.

FIGS. 6A and 6B each include a series of graphs used to help illustrate how FMCW chirps having different slopes can experience reduced interference.

FIGS. 7A and 7B are illustrations of FMCW transmission sequences, according to some embodiments.

FIG. 8 is an illustration of an enhanced FMCW transmission sequence in which half the allocated bandwidth for each chirp is used in a manner that prevents frequency jumping.

FIG. 9 is a call flow diagram of a process by which a configuring node may coordinate the performance of RF sensing by one or more sensing nodes, according to an embodiment.

FIG. 10 is a flow diagram of a method of FMCW slope scrambling at a sensing node for RF sensing, according to an embodiment.

FIG. 11 is a flow diagram of a method of providing an FMCW slope scrambling configuration for RF sensing, according to an embodiment.

FIG. 12 is a block diagram of an embodiment of a mobile sensing node.

FIG. 13 is a block diagram of an embodiment of a stationary sensing node.

FIG. 14 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c). Drawings may be simplified for discussion purposes and may not reflect certain features of embodiments (e.g., sizes/dimensions, components, etc.) used in real-world applications.

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” and variants refer to a process by which one or more objects (which also may be referred to as “targets”) are detected using RF signals transmitted by a transmitting device and, after reflecting from the object(s), received by a receiving device. In a monostatic configuration, the transmitting and receiving devices are the same device. In a bistatic configuration, one device transmits RF signals, and another device receives reflections of the RF signals from one or more objects. In multi-static configuration, one or more receiving devices are separate from one or more transmitting devices. As used herein, the term “static” in the terms “monostatic,” “bistatic,” and “multistatic” (or “multi-static”) are meant to conform with historical literature on RF sensing but are not limited to “static” or stationary sensing nodes. As described herein, in some embodiments, sensing nodes may be mobile. As described herein, devices performing RF sensing may be referred to as “RF sensing nodes” or simply “sensing nodes.” In a bistatic or multi-static configuration, transmitting devices may be referred to as “transmitting nodes,” “Tx sensing nodes,” or “Tx nodes,” and receiving devices may be referred to as “receiving nodes,” “Rx sensing nodes,” or “Rx nodes.” A sensing node may be referred to as either or both in a monostatic configuration. As described hereafter in more detail, a receiving device can make measurements of these reflected RF signals to determine one or more characteristics of one or more objects, such as location, range, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “reference signals” and the like may be used to refer to signals used for positioning of a user equipment (UE), sensing of active and/or passive objects by one or more sensing nodes, or a combination thereof. As described in more detail herein, such signals may comprise any of a variety of signal types. This may include but is not limited to, a positioning reference signal (PRS), sounding reference signal (SRS), synchronization signal block (SSB), channel start information reference signal (CSI-RS), or any combination thereof.

Techniques provided herein may apply to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF sensing with frequencies outside this range. For example, in some embodiments, 5G NR frequency bands (e.g., 28 GHz) may be used. Because RF sensing may be performed in the same bands as communication, hardware may be utilized for both communication and RF sensing. For example, one or more of the components of an RF sensing system as described herein may be included in a wireless modem (e.g., Wi-Fi or NR modem), a UE (e.g., an extended device), or the like. Additionally, techniques may apply to RF signals comprising any of a variety of pulse types, including compressed pulses (e.g., comprising Chirp, Golay, Barker, Ipatov, or m sequences) may be utilized. That said, embodiments are not limited to such frequencies and/or pulse types. Additionally, because the RF sensing system may be capable of sending RF signals for communication (e.g., using 802.11 or NR wireless technology), embodiments may leverage channel estimation and/or other communication-related functions for providing RF sensing functionality as described herein. Accordingly, the pulses may be the same as those used in at least some aspects.

As noted, RF sensing may be performed by wireless devices, or sensing nodes, and can have a wide range of consumer, industrial, commercial, and other applications. RF sensing may utilize one or more sensing nodes and may be coordinated by a wireless network to detect and/or track or target objects. To perform RF sensing, these sensing nodes can transmit and receive RF signals, including frequency-modulated continuous wave (FMCW) signals. FMCW signals may be particularly advantageous for performing RF sensing because they can utilize a large bandwidth while maintaining low complexity, thereby enabling RF implementation that is both high accuracy and low cost. However, simplicity in the FMCW waveform can make it more vulnerable to interference, which can present a challenge when scaling RF sensing within a wireless network.

Embodiments described herein address these and other issues by utilizing slope “scrambling,” which can reduce and randomize cross-node FMCW interference, enabling more accurate RF sensing in an environment having multiple FMCW RF sensing signals. Various aspects relate generally to the field of RF-based sensing in a wireless network. Some aspects more specifically relate to providing a slope configuration to a sensing node to enable more efficient RF sensing of one or more targets. Some examples include a sensing node, such as a user equipment (UE), receiving a slope configuration from a configuring node of a wireless network, such as a sensing server, in which the slope configuration includes one or more parameters indicative of a frequency slope value for each chirp of an FMCW transmission sequence. The sensing node may then perform an RF sensing function (e.g., transmitting and/or receiving the FMCW transmission sequence) in accordance with the slope configuration. As noted, to help ensure a random (or pseudorandom) sequence, the FMCW transmission sequence may be associated with a scrambling ID that may be based on the cell, UE ID, frame number, slot index, symbol index, or any combination thereof. Further techniques may be used to avoid a frequency jump in the FMCW transmission sequence to facilitate the transmission and/or receipt of the FMCW transmission sequence.

Particular aspects of the subject matter described in this disclosure can be implemented to realize one or more of the following potential advantages. In some examples, by randomizing the FMCW transmission sequence, embodiments may provide for reduced interference for FMCW-based RF sensing in an environment having multiple sensing nodes and multiple FMCW transmissions. In some examples, utilizing a triangular FMCW waveform that uses different halves of an allocated bandwidth for positively and negatively modulated chirps, embodiments can help avoid frequency jumps in the FMCW transmission sequence, allowing a larger number of devices (including low-cost implementations) to transmit and/or receive the FMCW transmission sequence. These and other advantages will be apparent to persons of ordinary skill in light of the disclosed embodiments detailed hereafter. A discussion of embodiments is provided after a brief discussion of relevant technology and context/background in which embodiments may be used.

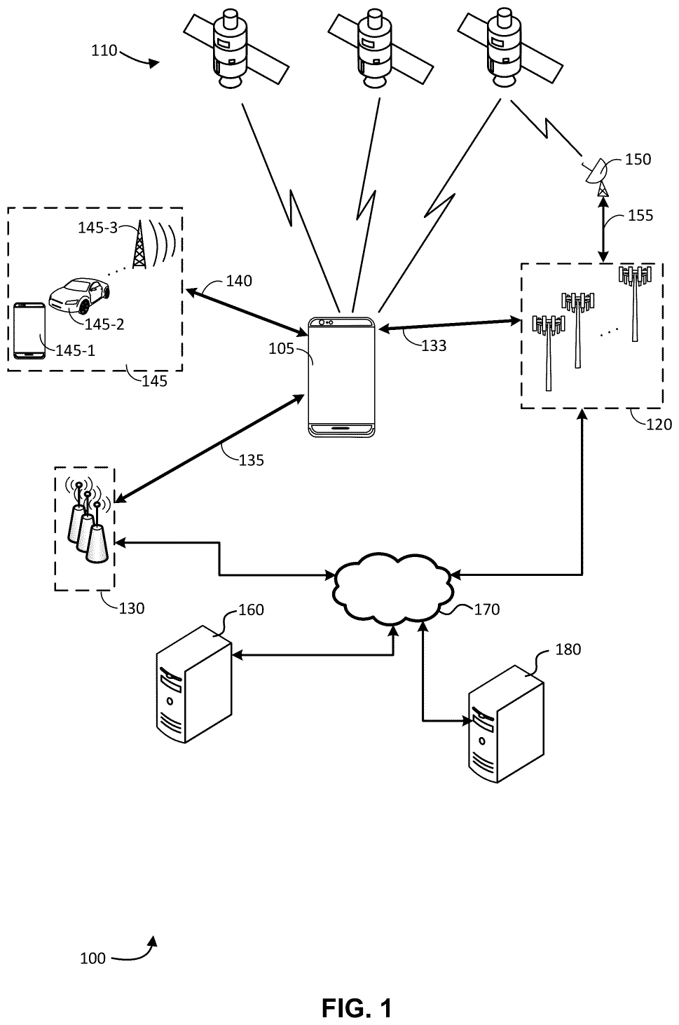

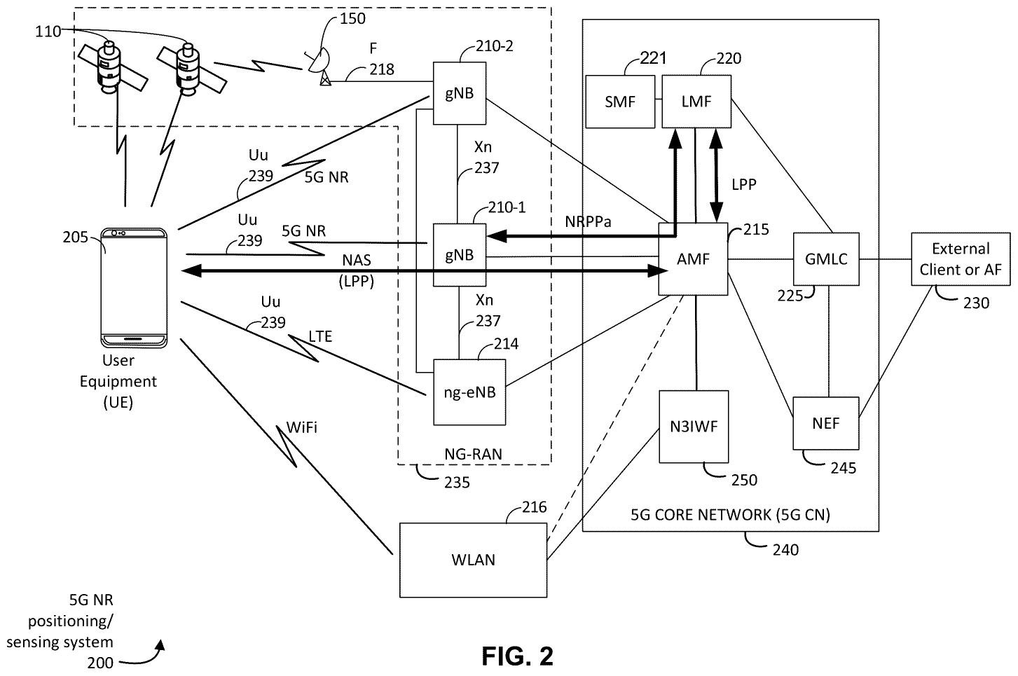

FIG. 1 is a simplified illustration of a positioning/sensing system 100, which may be implemented in conjunction with and/or as part of a wireless communication system (e.g., a cellular communication network) which a mobile device 105, location/sensing server 160, and/or other components of the positioning/sensing system 100 can use the techniques provided herein for slope scrambling for FMCW-based RF sensing, according to an embodiment. The techniques described herein may be implemented by one or more components of the positioning/sensing system 100, however, the techniques described herein are not limited to such components and may be implemented in other types of systems (not shown). The positioning/sensing system 100 can include a mobile device 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location/sensing server 160; network 170; and external client 180. Generally put, the positioning/sensing system 100 can estimate the location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices). Additional details regarding particular location estimation/sensing techniques are discussed with regard to FIG. 2.

It should be noted that FIG. 1 provides only a generalized illustration of various components, any or all of which may be utilized as appropriate, and each of which may be duplicated, as necessary. Specifically, although only one mobile device 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location/sensing server 160, by accessing the network 170 via a base station 120 using a first communication link 133. Additionally or alternatively, because APs 130 also may be communicatively coupled with the network 170, mobile device 105 may communicate with network-connected and Internet-connected devices, including location/sensing server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location/sensing server 160. In some embodiments, the location/sensing server 160 may comprise, a Discovered SLP (D-SLP) or an Emergency SLP (E-SLP). The location/sensing server 160 may also comprise an Enhanced Serving Mobile Location Center (E-SMLC) that supports location of mobile device 105 using a control plane (CP) location solution for LTE radio access by mobile device 105. The location/sensing server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location/sensing server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning/sensing system 100 (e.g., satellites 110, APs 130, base stations 120). The estimated location of the mobile device 105 can be estimated geometrically (e.g., using multiangulation and/or multilateration), based on the distance (range) and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As previously noted, the example positioning/sensing system 100 can be implemented using a wireless communication network, such as an LTE-based or 5G NR-based network, or a future 6G network. FIG. 2 shows a diagram of a 5G NR positioning/sensing system 200, illustrating an embodiment of a positioning/sensing system (e.g., positioning/sensing system 100) implemented in 5G NR. The 5G NR positioning/sensing system 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SMF 221 may coordinate RF sensing by the 5G NR positioning/sensing system 200. Here, the 5G NR positioning/sensing system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning/sensing system (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted, as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning/sensing system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such gNB 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE-based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location-related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220.

In a 5G NR positioning/sensing system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 205 may obtain location measurements (e.g., which may be the same as or similar to location measurements for a UE-assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, which is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

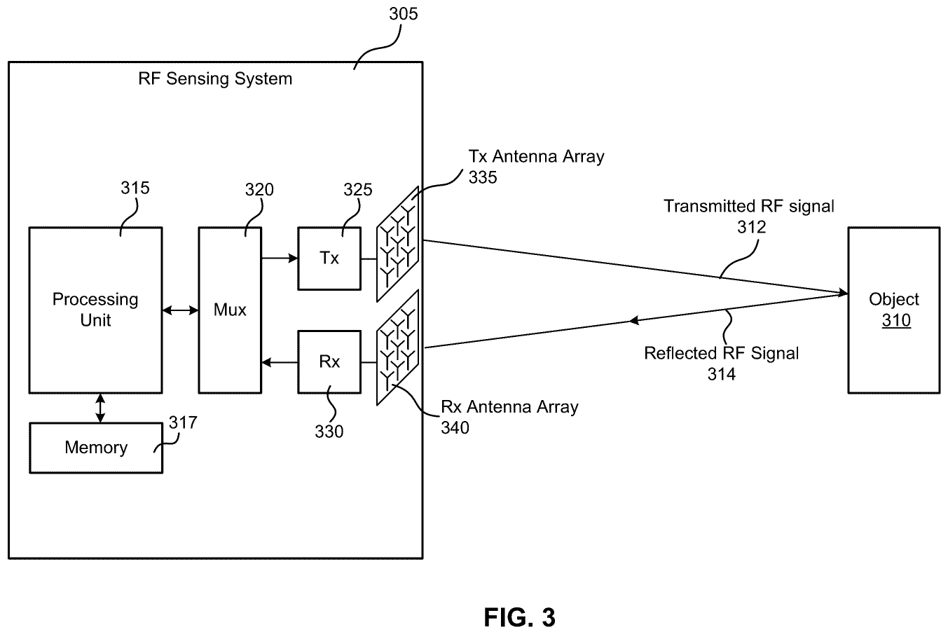

The principles described above with respect to UE-assisted positioning, UE-based positioning, UL-based positioning, DL-based positioning, and DL-UL based positioning may be generally extended to RF sensing. That is, RF sensing may be UE-based (e.g., originated from the UE) and/or UE assisted (e.g., originated from a non-UE entity), and may involve UL signals, DL signals, or both. However, RF sensing may differ from positioning in various ways. For example, as previously noted, RF sensing may involve the use of positioning reference signal (PRS), sounding reference signal (SRS), synchronization signal block (SSB), channel start information reference signal (CSI-RS), or any combination thereof. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof). Various aspects of RF sensing are described below FIG in more detail with respect to FIG. 3.

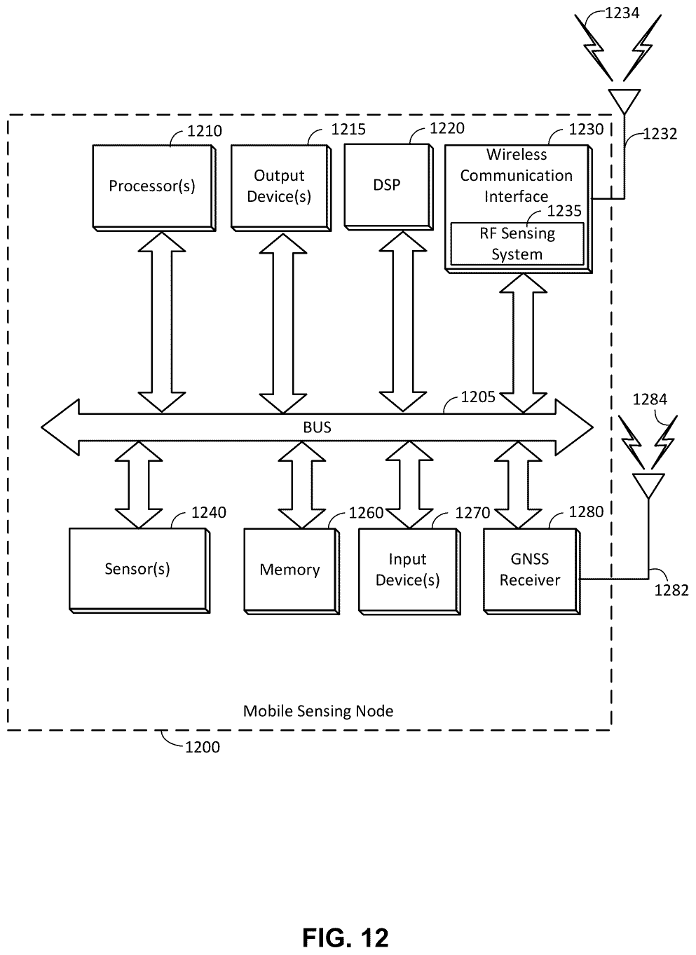

FIG. 3 is a diagram showing an example of an RF sensing system 305 and associated terminology. As used herein, the terms “waveform” and “sequence” and derivatives thereof are used interchangeably to refer to RF signals generated by a transmitter of the RF sensing system and received by a receiver of the RF sensing system for object detection. A “pulse” and derivatives thereof are generally referred to herein as waveforms comprising a sequence or complementary pair of sequences transmitted and received to generate a channel impulse response (CIR). The RF sensing system 305 may comprise a standalone device or may be integrated into a larger electronic device (e.g., the UE disclosed herein), such as a mobile phone, a base station/access node, a satellite, or other type of sensing node as described herein. (Example components of such electronic devices are illustrated in FIGS. 12-14, discussed in detail hereafter.) It can be noted that although the example RF sensing system 305 of FIG. 3 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 305 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 305 in FIG. 3, the RF sensing system 305 can detect the distance, direction, and/or speed of objects of an object 310 by generating a series of transmitted RF signals 312 (comprising one or more pulses). Some of these transmitted RF signals 312 reflect off of the object 310, and these reflected RF signals 314 (or “echoes”) are then processed by the RF sensing system 305 using beamforming (BF) and digital signal processing (DSP) techniques to determine the object's location (azimuth, elevation, velocity (e.g., from Doppler measurements), and range) relative to the RF sensing system 305. CFAR may be part of this processing, but may not necessarily be used in every instance, or “occasion,” in which RF sensing is performed.

To enable RF sensing, RF sensing system 305 may include a processing unit 315, memory 317, multiplexer (mux) 320, Tx processing circuitry 325, and Rx processing circuitry 330. (The RF sensing system 305 may include additional components not illustrated, such as a power source, user interface, or electronic interface). It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitries). Processing of the CIR may include object detecting, range, speed, or direction of arrival (DoA) estimation.

Beamforming is further enabled by a Tx antenna array 335 and an Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the RF sensing system 305. As a person of ordinary skill in the art will appreciate, the relative location of the Tx and Rx sides, in addition to various environmental factors can impact how spatial cancellation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF signals with frequencies outside this range. For example, in some embodiments, 5G frequency bands (e.g., 28 GHz) may be used.

Because RF sensing may be performed in the same frequency bands as communication (e.g., cellular and/or WLAN communication), hardware may be utilized for both communication and RF sensing, as previously noted. For example, one or more of the components of the RF sensing system 305 shown in FIG. 3 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, Ipatov, or m sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 305 may be integrated into an electronic device in which RF sensing is desired (e.g., mobile device 105 and/or UE 205). For example, the RF sensing system 305, which can perform RF sensing, may be part of the communication hardware found in modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 305 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian/unmanned aerial vehicle (UAV) intrusion detection in highways and railways, rainfall monitoring, flooding awareness, autonomous driving, automated guided vehicle (AGV) detection/tracking/collision avoidance, smart parking and assistance, UAV trajectory and tracking, crowd management, sleep/health monitoring, gesture recognition, extended reality (XR) streaming, public safety, search and rescue, and more. Further, RF sensing is expected to be incorporated into wireless standards (e.g., 6G), and therefore may be performed in the future in a cellular network.

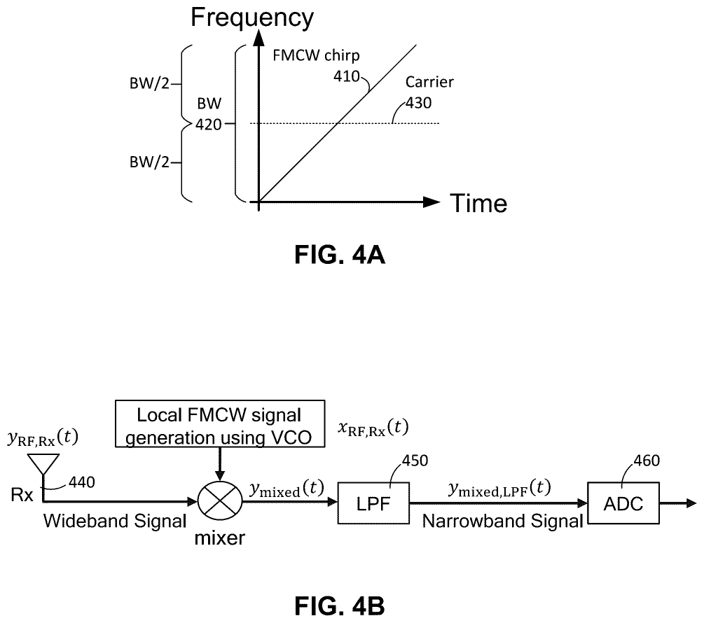

As noted, FMCW is a signal of particular interest in RF sensing. It has a relatively low peak-to-average power ratio (PAPR) and can be implemented in all-class applications due to low ADC requirements stemming from the analog-heavy characteristics of FMCW processing. A relatively low-speed ADC may be used to sample the FMCW signal (e.g., from several GHz to less than 10 MHz), providing narrowband baseband processing requirements for wideband RF sensing. Further, FMCW can allow for low-complexity full duplex sensing. Stretch processing can be used to help isolate the echo signal while canceling interference. Because interference cancellation is done in the analog domain, it can protect the dynamic range of the echo signals after the ADC. FIG. 4, described below, includes additional details regarding FMCW signals.

FIG. 4A is a diagram of the frequency of an example FMCW chirp 410, plotted over time. Here, the FMCW chirp 410 comprises a linear increase in frequency over time, across an allocated bandwidth 420 for the FMCW signal. More particularly, the FMCW chirp 410 represents a linear ramp-up in frequency across the bandwidth 420 from a minimum frequency to a maximum frequency, centered at a carrier 430. In FMCW chirp that increases in this matter may be referred to as an “up-chirp.” A “down-chirp” (not shown) is an FMCW chirp that ramps down in a similar manner: linearly decreasing in frequency across the bandwidth 420 from a maximum frequency to a minimum frequency, centered at the carrier 430. As described in more detail below, multiple chirps transmitted in succession may comprise a transmission sequence.

FIG. 4B is a diagram illustrating how the analog processing of FMCW signals may be performed prior to digital conversion, according to some embodiments. The components illustrated in FIG. 4B may, for example, correspond with Rx processing circuitry 330 in the RF sensing system 305 of FIG. 3, which may be included as a discrete component or incorporated into an existing communication component (e.g., wireless radio) of a wireless electronic device (e.g., mobile device 105 and/or UE 205). Here, a wireless FMCW signal is received at an Rx antenna 440 (or Rx antenna array), producing a wideband signal that is then mixed with a locally-generated FMCW signal (which may be generated using a voltage-controlled oscillator (VCO)). The resulting mixed signal is then passed through a low-pass filter (LPF) 450, and the resulting narrowband signal is then provided to an ADC 460. As previously noted, the narrowband signal required to process FMCW signals is relatively low, enabling the use of a relatively low-speed ADC 460. In turn, this can allow relatively low-cost Rx sensing nodes to receive and process FMCW signals. Although the simplicity of FMCW signals offers many advantages with respect to accuracy and low-cost processing, there are some drawbacks.

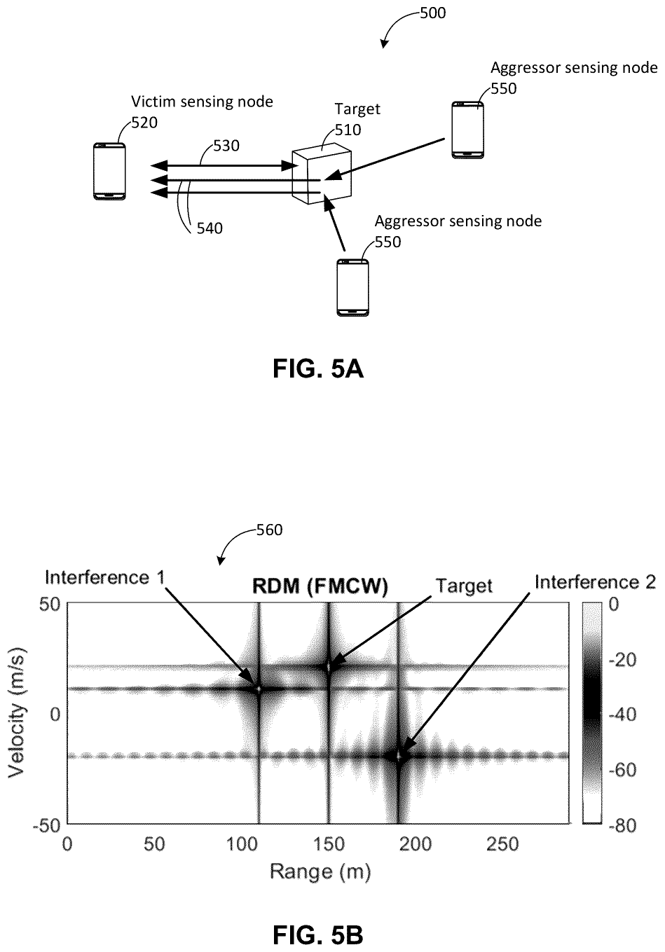

FIG. 5A is a simplified illustration of an example scenario 500 in which FMCW signals may interfere with the detection of a target 510. In this example, a “victim” sensing node 520 attempting to detect the target 510 with its own FMCW signal 530 is subject to interfering FMCW signals 540 from two “aggressor” sensing nodes 550. That is, the interfering FMCW signals 540 are not part of the coordinated (e.g., multi-static) RF sensing configuration, but instead may be echoes of FMCW signals transmitted by each aggressor sensing node 550 in an attempt to detect the target 510 using RF sensing.

FIG. 5B illustrates a resulting range-Doppler map 560 at the victim sensing node 520 of FIG. 5A, which plots received signal amplitude over velocity and range. As can be seen, there are three peaks in signal strength: a desired peak (labeled “Target”) from the target corresponding with the victim sensing node's FMCW signal 530, and two undesired peaks (labeled “Interference 1” and “Interference 2”) representing interference from the interfering FMCW signals 540. Here, the victim sensing node 520 and aggressor sensing nodes 550 may be utilizing the same FMCW signal (the same FMCW transmission sequence). As such, the victim sensing node 520 is unable to determine which peak in the range Doppler map 560 represents the target, and which represents interference. The victim sensing node 520 may therefore incorrectly determine that there are three targets, based on the interfering FMCW signals 540 from the aggressor sensing nodes 550.

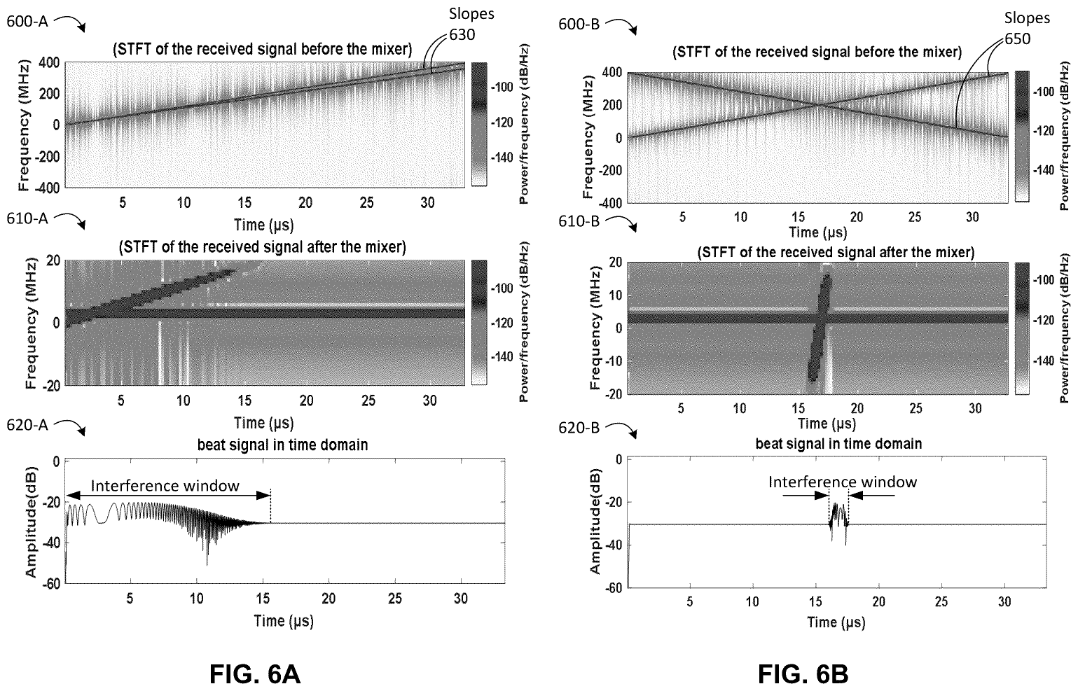

As previously noted, embodiments herein help a sensing node distinguish a desired signal from an undesired signal by using slope “scrambling” in FMCW transmission sequences, thereby helping reduce and randomize interference. The concepts underlying how slope scrambling can be a successful interference reduction technique are described below with respect to FIGS. 6A and 6B.

FIGS. 6A and 6B each include a series of graphs used to help illustrate how FMCW chirps having different slopes can experience reduced interference. The first series of graphs in FIG. 6A illustrates interference between two FMCW signals having very similar slopes. The slopes 630 can be seen in the first graph 600-A, which plots the frequency of the short-time Fourier transform (STFT) of the received signal before the mixer (e.g., as shown in FIG. 4B). The second graph 610-A and third graph 620-A help illustrate the corresponding interference, respectively illustrating the STFT of the received signal after the mixer and the beat signaling the time domain. As illustrated in the third graph 620-A the interference window (or window of time during which interference occurs) is relatively lengthy and occurs at the beginning of the received signal.

The second series of graphs in FIG. 6B illustrates interference between two FMCW signals having different slopes (e.g., an up-chirp and a down-chirp). The slopes 650 can be seen in the first graph 600-B, which plots the frequency of the STFT of the received signal before the mixer. The second graph 610-B and third graph 620-B of FIG. 6B help illustrate the corresponding interference from the received signals shown in the first graph 600-B, respectively illustrating the STFT of the received signal after the mixer and the beat signaling the time domain. As illustrated in the third graph 620-B the interference window (or window of time during which interference occurs) is relatively short and occurs at the middle of the received signal.

Two observations regarding interference between FMCW signals may be made in view of the graphs of FIGS. 6A and 6B. The first is that an increase in the difference between the chirp rate (e.g., rate of frequency change, or slope) of the FMCW signals can result in a reduced interference level. The second is that the time domain location of the interference may differ, depending on the chirp rate difference.

In view of these observations, embodiments can implement a design to reduce and randomize cross-node FMCW interference through the use of slip scrambling. This can allow more users to operate FMCW-based RF sensing within the same time and frequency resource than would otherwise be possible in FMCW-based RF sensing. Although FMCW signals are non-orthogonal and therefore introduce interference, this interference is randomized and may be significantly reduced or eliminated at an Rx sensing node while processing the received FMCW signals. This can also enable efficient multi-user/multi-cell multiplexing.

According to some embodiments, slope scrambling can involve using a basis FMCW waveform, such as a saw or triangle waveform, to transmit an FMCW transmission sequence. A saw FMCW waveform represents a single linear up-chirp (e.g., as shown in FIG. 4A) or down-chirp. A triangle FMCW waveform represents a linear increase from a starting frequency to a maximum frequency followed by a linear decrease back to the starting frequency.

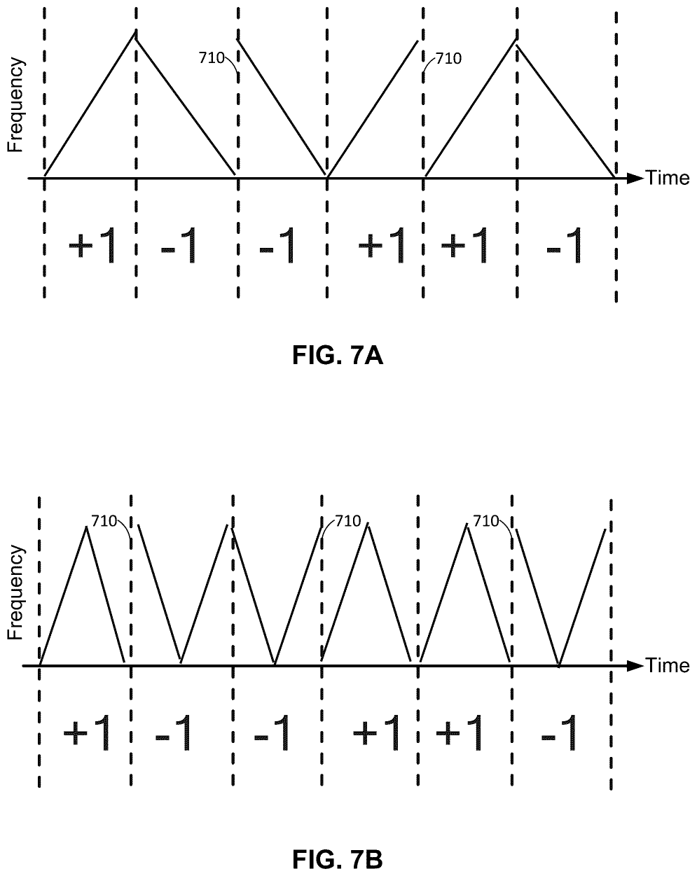

FIGS. 7A and 7B are illustrations of FMCW transmission sequences, according to some embodiments. Here, FIG. 7A represents a binary phase-shift keying (BPSK) modulated sequence (+1, −1, −1, +1, +1, −1) transmitted using a saw waveform as a basis FMCW waveform. FIG. 7B represents the same BPSK-modulated sequence transmitted using a triangular waveform as a basis FMCW waveform.

According to some embodiments, each sensing node (or set of sensing nodes in a bistatic or multi-static configuration) may receive a scrambling ID for performing an RF sensing function. The scrambling ID may be representative of an FMCW transmission sequence, which may be different than other sequences used by other (e.g., nearby) sensing nodes for other RF sensing functions. The sequence may comprise an m sequence, gold sequence, or other sequence known to have autocorrelation/cross-correlation properties that are helpful in reducing interference. As previously noted, BTSK modulation may be used, although alternative embodiments may use other forms of modulation (e.g., quadrature phase shift keying (QPSK)). To help ensure different sensing nodes receive different scrambling IDs, a scrambling ID may be a function of cell and/or UE ID, an orthogonal frequency division multiplexing (OFDM) frame number, an OFDM slot index, an OFDM symbol index, or any combination thereof. For scenarios in which multiple sensing nodes are used in a single RF sensing function (e.g., to perform bistatic or multi-static RF sensing), the scrambling ID may be based on information (e.g., the UE ID) regarding one of the participating sensing nodes.

According to some embodiments, to generate the FMCW transmission sequence (e.g., for transmission by a Tx sensing node and/or reception by an Rx sensing node), the sensing node may use the following equation:

$${γ}_{i} = μ * {α}_{i} , i = 1 , 2 , … , N , \qquad ( Eqn . 1 )$$

where γᵢ is the FMCW transmission sequence, μ is the chirp rate in the basis FMCW waveform, and αᵢ is the modulated sequence.

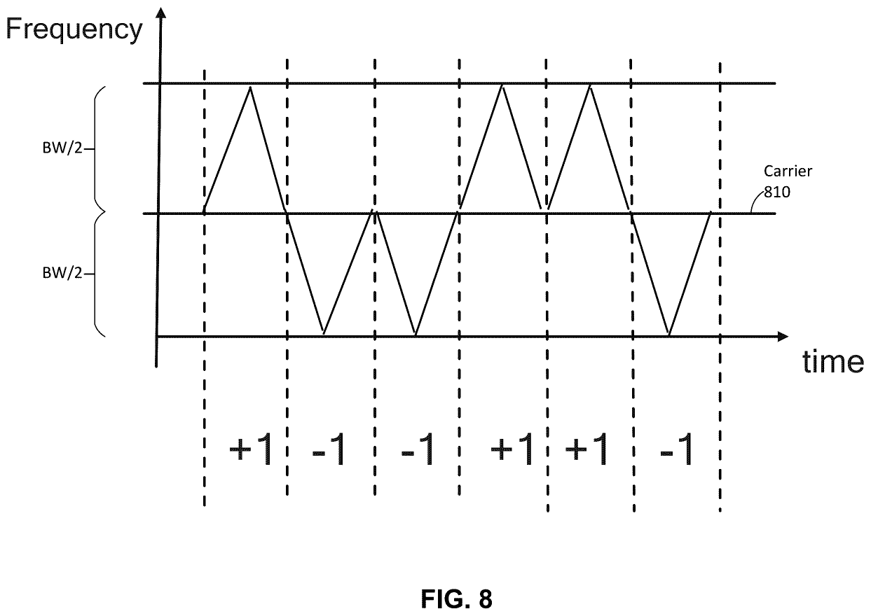

Returning to FIGS. 7A and 7B, it can be noted that frequency jumps occur at various times 710 during each of the sequences. This can be problematic in certain circumstances where a sensing node is incapable of making the frequency jump prior to the next chirp and the transmission sequence. As such, the use of such sequences without further adjustments may be limiting in some circumstances, allowing only certain types of sensing nodes to transmit and/or receive the FMCW transmission sequences. However, this may be addressed, as shown in FIG. 8 and described below

FIG. 8 is an illustration of a BPSK-modulated sequence using a triangular waveform as a basis FMCW waveform, similar to FIG. 7B, but utilizing half the allocated bandwidth (BW/2) for each chirp in a manner that prevents frequency jumping. More specifically, positive values in the transmission sequence use the upper half of the bandwidth (from a carrier 810 to a maximum frequency), and negative values in the transmission sequence use the lower half of the bandwidth (from the carrier to a minimum frequency). In contrast to FIG. 7B, each chirp in the sequence of FIG. 8 returns to the same initial frequency (e.g., carrier 810). Using this technique, no frequency jumping occurs, regardless of the sequence. Further, because the sequence uses both positive and negative values, it uses the entire allocated bandwidth, thereby having the same accuracy as the sequences of FIGS. 7A and 7B have. With no frequency jumping, this technique would result in fewer implementation challenges, enabling more devices (including low-cost devices) to serve as sensing nodes for RF sensing.

The principles used by the example signal in FIG. 8 can be extended more broadly to other FMCW signals for RF sensing. That is, each chirp in an FMCW transmission sequences may be transmitted with (e.g., approximately) half of the bandwidth allocated for the FMCW transmission, starting and ending at substantially the same frequency. Linear slope(s) of the chirps may be defined as described herein. Using, for example, a basis waveform, chirp rate, and modulation value.

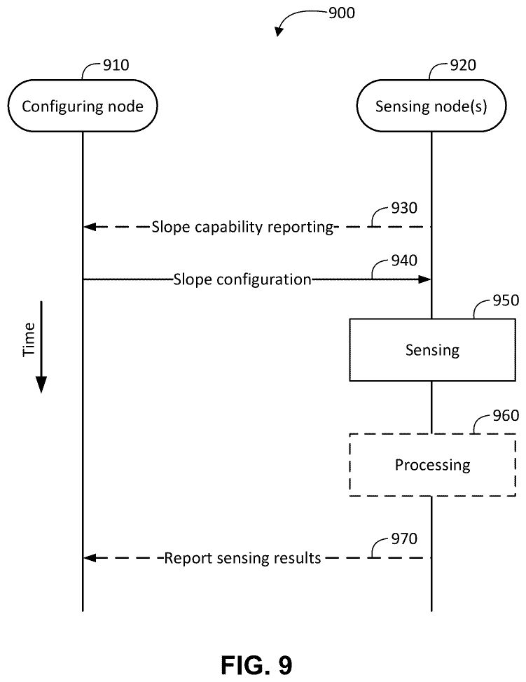

To coordinate sensing across multiple sensing nodes, a configuring node may be used. FIG. 9, discussed below, provides an example of how a configuring node may be used to coordinate such sensing, according to some embodiments.

FIG. 9 is a call flow diagram of a process 900 by which a configuring node 910 may coordinate the performance of RF sensing by one or more sensing nodes 920. Optional functionality (which is described in more detail below) is illustrated using dashed lines. As previously noted, a sensing node 920 may comprise a mobile device (e.g., UE) or a base station (e.g., gNB) in a cellular network. Further, a configuring node 910 may be a server or other node used to coordinate sensing in the cellular network. As such, the configuring node 910 may comprise a sensing server (e.g., SMF 221 of FIG. 2) or a base station (e.g., gNB 210 of FIG. 2). Some or all portions of the process 900 may be performed as an independent process, and/or may be incorporated into other processes executed by sensing nodes (e.g., other types of capability reporting, sensing configuration, etc.).

The process 900 may begin with optional capability reporting, as indicated at arrow 930. Generally speaking, this capability reporting may indicate the capabilities of the sensing node(s) 920 with respect to FMCW signals the sensing node(s) 920 can and/or cannot generate. As such, the slope capability reporting may include limitations regarding chirp rate, particular sequences it can and/or cannot use, etc. If incorporated into a standard in which certain capabilities are indexed, the slope capability reporting may, for example, include index numbers corresponding to its capabilities. According to some embodiments, the slope capability reporting at arrow 930 may also include information used by the configuring node 910 to determine a scrambling ID. According to some embodiments, the sensing node(s) 920 may provide the slope capability reporting at arrow 930 in response to a request (not shown) from the configuring node 910. The optionality of the slope capability reporting may be due to certain circumstances in which slope capabilities are known or established beforehand (e.g., standardized), in which case slope capability reporting may not be needed.

The process 900 may continue with the functionality of arrow 940, in which the configuring node 910 provides a slope configuration to the sensing node(s) 920. As noted above, the slope configuration at arrow 940 may include a scrambling ID for the sensing node(s) 920 to use in the transmission and/or reception of the FMCW transmission sequence. As previously noted, the scrambling ID may be based on various factors and may include one or more parameters indicative of a frequency slope value (e.g., chirp rate) for each chirp in the transmission sequence, as well as the sequence itself. According to some embodiments, the slope configuration provided at arrow 940 may include information indicative of the chirp rate μ and modulated sequence αᵢ to allow the sensing node(s) 920 to calculate the FMCW transmission sequence using Eqn. 1, for example. According to some embodiments, the chirp rate may be time-varying to provide further reduction/randomization in interference. According to some embodiments, the slope configuration may further indicate a basis FMCW waveform (e.g., saw or triangular) and may optionally further indicate whether an enhanced waveform as shown in FIG. 8 is to be used.

At block 950, the sensing node(s) 920 may perform the sensing function. For a Tx sensing node, this may simply involve transmitting the FMCW transmission sequence at one or more specified times. (These one or more times may be provided in the slope configuration, or in a separate sensing configuration.) For an Rx sensing node, this may involve pre-programming its hardware to generate the corresponding FMCW transmission sequence to be able to perform correlation with a received FMCW transmission sequence.

The optional functionality shown at block 960 and arrow 970 may be performed, for example, when the sensing node(s) 920 comprises an Rx sensing node. That is, the processing that occurs at block 960 may include the processing previously described with respect to FIG. 4B, and may further include identifying one or more targets using the RF sensing data. According to some embodiments, an Rx sensing node may perform a two-dimensional Fast Fourier Transform (2D-FFT) after the stretch processing, to extract a range-Doppler profile. Due to the slope scrambling, only the target-related echoes may lead to peaks in the range-Doppler profile (or either the range or Doppler profile). Put differently, the interference is randomized and hence will be spread in the range-Doppler profile (or either the range or Doppler profile). According to some embodiments, a constant false alarm rate (CFAR) detector and/or another advanced algorithm may be used to filter out the spread interference.

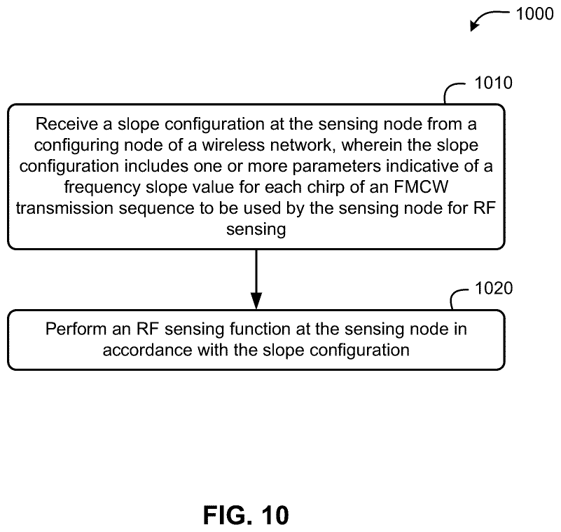

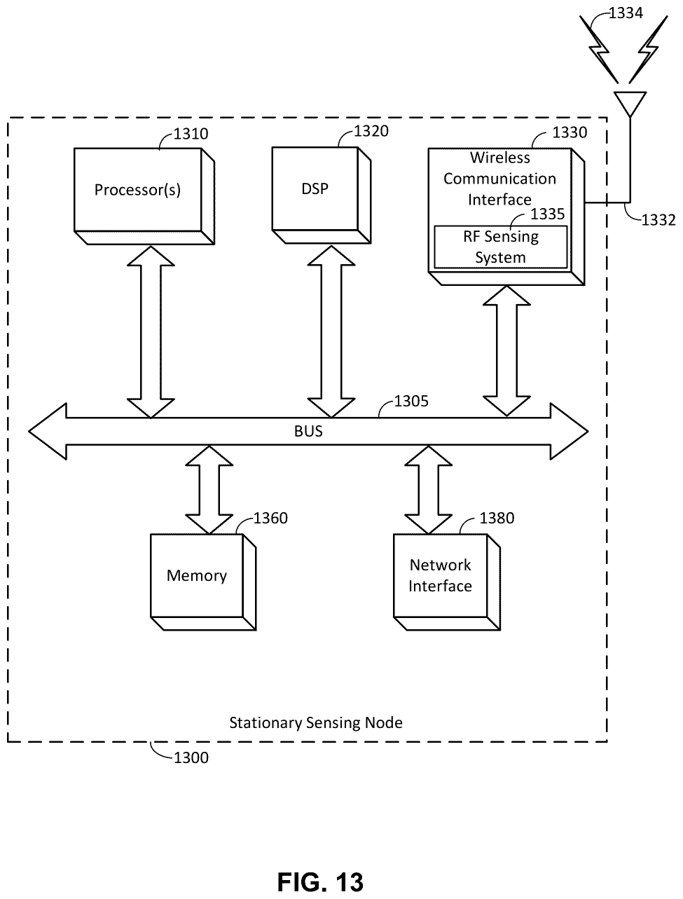

FIG. 10 is a flow diagram of a method 1000 of FMCW slope scrambling at a sensing node for RF sensing, according to an embodiment. Aspects of the method 1000 may correspond with the functions performed by the sensing node(s) 920 in FIG. 9 described above, for example. Means for performing the functionality illustrated in one or more of the blocks shown in FIG. 10 may be performed by hardware and/or software components of a sensing node, such as a UE or base station. Example components of a mobile sensing node (e.g., UE) and a stationary sensing node (e.g., base station) are illustrated in FIGS. 12 and 13, respectively, which are described in more detail below.

At block 1010, the functionality comprises receiving a slope configuration at the sensing node from a configuring node of a wireless network, wherein the slope configuration includes one or more parameters indicative of a frequency slope value for each chirp of an FMCW transmission sequence to be used by the sensing node for RF sensing. As noted elsewhere herein, the wireless network may comprise a cellular network (e.g., 5G, 6G network), and the configuring node of the network may comprise a server within the network (e.g., an SMF or equivalent), a base station, or another node within the network. Further, according to some embodiments, the slope configuration may accompany or be included in another configuration, such as a sensing configuration provided by the configuring node to the sensing node. As noted with regard to FIG. 9, a sensing node may provide some capability information (e.g., prior to receiving the slope configuration). As such, some embodiments may include sending slope capability information from the sensing node to the configuring node (e.g., prior to receiving the slope configuration), where the slope capability information is indicative of one or more frequency slopes with which the sensing node may perform the RF sensing function, and receiving the slope configuration is responsive to the sending of the slope capability information.

As noted, the one or more parameters indicative of the frequency slope value for each chirp may include a chirp rate and a scrambling sequence. The chirp rate can impact the grade of the frequency slope, and the scrambling sequence and indicate whether the slope is positive or negative. As also previously described, according to some embodiments, the scrambling sequence may be associated with a scrambling ID, and wherein the scrambling ID is a function of a wireless cell of the sensing node, a user equipment (UE) ID of the sensing node, an orthogonal frequency division multiplexing (OFDM) frame number, an OFDM slot index, an OFDM symbol index, or any combination thereof. As also described herein with respect to FIG. 8, according to some embodiments, each chirp of the FMCW transmission sequence may utilize half of a bandwidth allocated for the transmission of the FMCW transmission sequence and may begin and end on substantially the same frequency.

Depending on desired functionality, the slope configuration may include additional information. For example, according to some embodiments, the slope configuration can be further indicative of a basis FMCW waveform for each chirp of the FMCW transmission sequence, the basis FMCW waveform comprising a saw waveform or a triangular waveform. According to some embodiments, the respective frequency slope value for each chirp of the FMCW transmission sequence is either positive or negative, based on a BPSK modulation of the FMCW transmission sequence. In such embodiments, the basis FMCW waveform of the FMCW transmission sequence may comprise a triangular waveform such that a chirp having a respective positive frequency slope value comprises an FMCW transmission starting at a first initial frequency and including a substantially linear increase in frequency followed by a substantially linear decrease in frequency back to the first initial frequency, and a chirp having a respective negative frequency slope value comprises an FMCW transmission starting at a second initial frequency and including a substantially linear decrease in frequency followed by a substantially linear increase in frequency back to the second initial frequency. An example of this is illustrated in FIG. 7B. Further, some embodiments may utilize the enhanced slope scrambling shown in FIG. 8. In such embodiments, the first initial frequency is the same as the second initial frequency, wherein the chirp having the respective positive frequency slope value and the chirp having the respective negative frequency slope value each use substantially half of a bandwidth allocated for the transmission of the FMCW transmission sequence.

Means for performing functionality at block 1010 may comprise a bus 1205, one or more processors and 1210, a digital signal processor (DSP) 1220, wireless communication interface 1230 (including RF sensing system 1235), one or more memories 1260, and/or other components of a mobile sensing node 1200, as illustrated in FIG. 12. Additionally or alternatively, means for performing functionality at block 1010 may comprise a bus 1305, one or more processors and 1310, a digital signal processor (DSP) 1320, wireless communication interface 1330 (including RF sensing system 1335), one or more memories 1360, network interface 1380, and/or other components of a stationary sensing node 1300, as illustrated in FIG. 13.

At block 1020, the functionality comprises performing an RF sensing function at the sensing node in accordance with the slope configuration. As described with respect to FIG. 9, this may differ, depending on whether the sensing node is a Tx sensing node or an Rx sensing node. (Again, in some embodiments, the sensing node may comprise both.) As such, according to some embodiments, the sensing node comprises a transmit (Tx) sensing node, in which case performing the RF sensing function in accordance with the slope configuration may comprise transmitting the FMCW transmission sequence. Additionally or alternatively, the sensing node may comprise a receive (Rx) sensing node, in which case performing the RF sensing function in accordance with the slope configuration may comprise receiving the FMCW transmission sequence defined by the one or more parameters included in the slope configuration, and processing the received FMCW transmission sequence to extract a range-Doppler profile. This may be done, for example, using components as illustrated in FIG. 4B, described above. In such instances, processing the received FMCW transmission sequence may comprise correlating the received FMCW transmission sequence with an FMCW transmission sequence generated locally (e.g., based on the slope configuration). In embodiments in which the sensing node comprises an Rx sensing node, the method may further comprise detecting, with the Rx sensing node, one or more targets from the range-Doppler profile; and reporting sensing results from the Rx sensing node to the configuring node, the sensing results indicative of the one or more targets. The one or more targets can be extracted from the range-Doppler profile, for example. The sensing results indicative of the one or more targets can include various aspects of the one or more targets, including, for example, a location, range, velocity, size, etc. (or any combination thereof) of each target. The RF sensing data may comprise measurements of the received FMCW transmission sequence, which may reflect from one or more targets/objects. The RF sensing data may be obtained, for example, in accordance with a sensing configuration which may be provided by the configuring node and may coordinate the transmission of the received FMCW transmission sequence by a Tx sensing node and the receipt (measurement) of the FMCW transmission sequence by an Rx sensing node. As noted herein, in a monostatic configuration, a single device may comprise the Rx sensing node and the Tx sensing node, wherein as a bistatic or multi-static configuration will include the RF sensing node in a separate device from the Tx sensing node.

Means for performing functionality at block 1020 may comprise a bus 1205, one or more processors and 1210, a digital signal processor (DSP) 1220, wireless communication interface 1230 (including RF sensing system 1235), one or more memories 1260, and/or other components of a mobile sensing node 1200, as illustrated in FIG. 12. Additionally or alternatively, means for performing functionality at block 1020 may comprise a bus 1305, one or more processors and 1310, a digital signal processor (DSP) 1320, wireless communication interface 1330 (including RF sensing system 1335), one or more memories 1360, network interface 1380, and/or other components of a stationary sensing node 1300, as illustrated in FIG. 13.

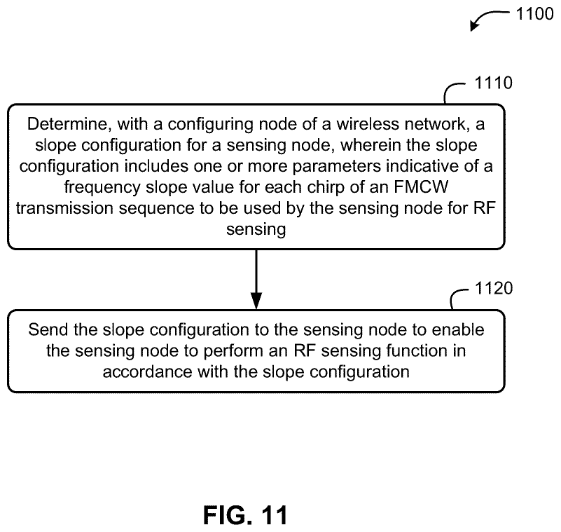

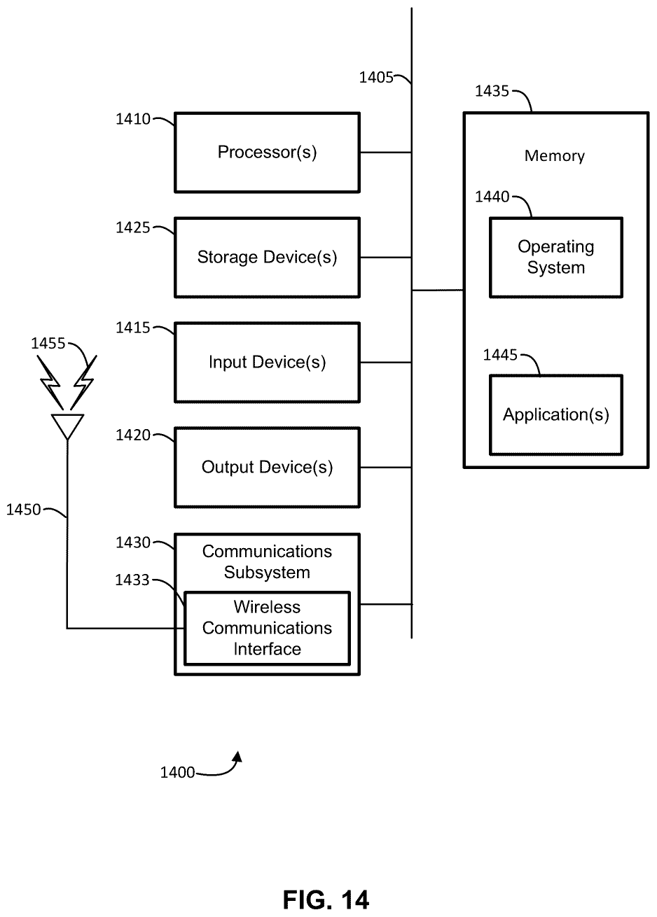

FIG. 11 is a flow diagram of a method 1100 of providing an FMCW slope scrambling configuration for RF sensing, according to an embodiment. Means for performing the functionality illustrated in one or more of the blocks shown in FIG. 11 may be performed by hardware and/or software components of a configuring node of a wireless network, such as a server (e.g., an SMF or equivalent in a 5G or 6G cellular network) or base station. Example components of a computer system that may execute and/or operate as such a server or base station are illustrated in FIG. 14, which is described in more detail below.

At block 1110, the functionality comprises determining, with a configuring node of a wireless network, a slope configuration for a sensing node, wherein the slope configuration includes one or more parameters indicative of a frequency slope value for each chirp of an FMCW transmission sequence to be used by the sensing node for RF sensing. As previously noted, the configuring node may comprise a base station or a server of the wireless network, and the sensing node may comprise a Tx sensing node, an Rx sensing node, or both. According to some embodiments, the one or more parameters may include a chirp rate and a scrambling sequence, e.g., as described herein. The scrambling sequence further may be associated with a scrambling identifier (ID), and wherein the scrambling ID is a function of a wireless cell of the sensing node, a user equipment (UE) ID of the sensing node, an orthogonal frequency division multiplexing (OFDM) frame number, an OFDM slot index, an OFDM symbol index, or any combination thereof.

According to some embodiments, the slope configuration may be determined based on slope capability information from the sensing node. As such, some embodiments may further comprise receiving slope capability information at the configuring node from the sensing node, prior to determining the slope configuration, wherein the slope capability information is indicative of one or more frequency slopes with which the sensing node may perform the RF sensing function, and wherein determining the slope configuration is based at least in part on the slope capability information.

Means for performing functionality at block 1110 may comprise a bus 1405, one or more processors 1410, one or more input devices 1415, one or more output devices 1420, a communications subsystem 1430, one or more memories 1435, and/or other components of a computer system 1400, as illustrated in FIG. 14.

At block 1120, the functionality comprises sending the slope configuration to the sensing node to enable the sensing node to perform an RF sensing function in accordance with the slope configuration. This may be done, for example, as described above with respect to the process 900 of FIG. 9. Further, as also noted, some embodiments may include or incorporate the slope configuration in another configuration that may be associated with RF sensing. This can include, for example, a larger RF sensing configuration provided by the configuring node to the sensing node, which may address aspects of the RF sensing other than slope scrambling (e.g., frequency/timing of RF sensing, Tx and/or Rx beams for RF sensing, etc.).

Means for performing functionality at block 1120 may comprise a bus 1405, one or more processors 1410, one or more input devices 1415, one or more output devices 1420, a communications subsystem 1430, one or more memories 1435, and/or other components of a computer system 1400, as illustrated in FIG. 14.

FIG. 12 is a block diagram of an embodiment of a mobile sensing node 1200, which can be utilized as described herein. For example, mobile sensing node 1200 may correspond to a mobile device (e.g., mobile device 105 of FIG. 1), UE (e.g., UE 205 of FIG. 2), sensing node (e.g., sensing nodes 520, 550 of FIG. 5A and/or 920 of FIG. 9), or the like, as described herein. Further, as described below, the mobile sensing node 1200 may implement an RF sensing system 1235, which may correspond to the RF sensing system 305 described above with respect to FIG. 3 (which itself may include components illustrated in FIG. 4B). Moreover, according to some embodiments, a mobile sensing node 1200 may function as a configuring node or device, as described herein, in some scenarios. As such, the mobile sensing node 1200 may be capable of performing some or all of the functionality described in the methods regarding sensing nodes and/or configuring nodes as described herein. It should be noted that FIG. 12 is meant only to provide a generalized illustration of various components, any or all of which may be utilized as appropriate.

The mobile sensing node 1200 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The mobile sensing node 1200 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The mobile sensing node 1200 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile sensing node 1200 to communicate and/or perform positioning with other devices as described in the embodiments above, with respect to WLAN and/or cellular technologies. The wireless communication interface 1230 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

As noted above, the mobile sensing node 1200 may implement an RF sensing system 1235. The RF sensing system 1235 may comprise the hardware and/or software elements described above with respect to FIG. 3. As illustrated in FIG. 12 and noted above, some or all of the RF sensing system 1235 may be implemented within a wireless communication interface 1230, which may utilize certain components for both communication and RF sensing. That said, embodiments are not so limited. Alternative embodiments may implement some or all of the RF sensing system 1235 separate from the wireless communication interface 1230 (e.g., in cases where RF sensing may utilize different frequencies and/or different hardware/software components than the wireless communication interface 1230).

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The mobile sensing node 1200 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile sensing node 1200 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information. As noted in the description above, sensors 1240 may be used, for example, to determine a velocity of the mobile sensing node, which may be reported to a configuring device, according to some embodiments.

Embodiments of the mobile sensing node 1200 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the mobile sensing node 1200, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS), and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1210 or DSP 1220.

The mobile sensing node 1200 may further include and/or be in communication with a memory 1260. The memory 1260 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the mobile sensing node 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the mobile sensing node 1200 (and/or processor(s) 1210 or DSP 1220 within mobile sensing node 1200). In some embodiments, then, such code and/or instructions can be used to configure and/or adapt a general-purpose computer (or other device) to perform one or more operations in accordance with the described methods.

FIG. 13 is a block diagram of an embodiment of a stationary sensing node 1300, which can be utilized as described herein. For example, stationary sensing node 1300 may correspond to a base station or access node (e.g., base station 120 of FIG. 1 and/or access nodes 210, 214, and 216 of FIG. 2), sensing node (e.g., sensing nodes 520, 550 of FIG. 5A and/or 920 of FIG. 9), or the like, as described herein. Further, as described below, the stationary sensing node 1300 may implement an RF sensing system 1335, which may correspond to the RF sensing system described above with respect to FIG. 3 (which itself may include components illustrated in FIG. 4B). Moreover, according to some embodiments, a stationary sensing node 1300 may function as a configuring node or device, as described herein, in some scenarios. As such, the mobile sensing node 1200 may be capable of performing some or all of the functionality described in the methods regarding sensing nodes and/or configuring nodes as described herein. It should be noted that FIG. 13 is meant only to provide a generalized illustration of various components, any or all of which may be utilized as appropriate. In some embodiments, the stationary sensing node 1300 may correspond to a gNB, an ng-eNB, and/or (more generally) a TRP. In some cases, a stationary sensing node 1300 may comprise multiple TRPs—e.g. with each TRP associated with a different antenna or a different antenna array of the stationary sensing node 1300 (e.g., 1332). As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by a stationary sensing node 1300 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 13.

The stationary sensing node 1300 is shown comprising hardware elements that can be electrically coupled via a bus 1305 (or may otherwise be in communication, as appropriate). The hardware elements may include a processor(s) 1310 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below), according to some embodiments. The stationary sensing node 1300 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The stationary sensing node 1300 might also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the stationary sensing node 1300 to communicate as described herein. The wireless communication interface 1330 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 1332 that send and/or receive wireless signals 1334. According to some embodiments, one or more wireless communication antenna(s) 1332 may comprise one or more antenna arrays, which may be capable of beamforming.

As noted above, the stationary sensing node 1300 may implement an RF sensing system 1335. The RF sensing system 1335 may comprise the hardware and/or software elements described above with respect to FIG. 3. As illustrated in FIG. 13 and noted above, some or all of the RF sensing system 1335 may be implemented within a wireless communication interface 1330, which may utilize certain components for both communication and RF sensing. That said, embodiments are not so limited. Alternative embodiments may implement some or all of the RF sensing system 1335 separate from the wireless communication interface 1330 (e.g., in cases where RF sensing may utilize different frequencies and/or different hardware/software components then the wireless communication interface 1330).

The stationary sensing node 1300 may also include a network interface 1380, which can include support of wireline communication technologies. The network interface 1380 may include a modem, network card, chipset, and/or the like. The network interface 1380 may include one or more input and/or output communication interfaces to permit data to be exchanged with a network, communication network servers, computer systems, and/or any other electronic devices described herein.

In many embodiments, the stationary sensing node 1300 may further comprise a memory 1360. The memory 1360 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1360 of the stationary sensing node 1300 also may comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the stationary sensing node 1300 (and/or processor(s) 1310 or DSP 1320 within stationary sensing node 1300). In some embodiments, then, such code and/or instructions can be used to configure and/or adapt a general-purpose computer (or other device) to perform one or more operations in accordance with the described methods.

FIG. 14 is a block diagram of an embodiment of a computer system 1400, which may be used, in whole or in part, to provide the functions of one or more components and/or devices as described in the embodiments herein. The computer system 1400, for example, may be utilized within and/or executed by a server (e.g., location server/LMF or sensing server/SMF) or base station (e.g., gNB), which may perform the functions of a configuring node (e.g., configuring node 910 of FIG. 9) as described herein. It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processor(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, as well as wired technologies (such as Ethernet, coaxial communications, universal serial bus (USB), and the like). The wireless communication interface 1433 may comprise one or more wireless transceivers that may send and receive wireless signals 1455 (e.g., signals according to 5G NR or LTE) via wireless antenna(s) 1450. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including UE, base stations and/or other transmission reception points (TRPs), satellites, and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of frequency-modulated continuous wave (FMCW) slope scrambling at a sensing node for radio frequency (RF) sensing, the method comprising: receiving a slope configuration at the sensing node from a configuring node of a wireless network, wherein the slope configuration includes one or more parameters indicative of a frequency slope value for each chirp of an FMCW transmission sequence to be used by the sensing node for RF sensing; and performing an RF sensing function at the sensing node in accordance with the slope configuration.

Clause 2. The method of clause 1, further comprising sending slope capability information from the sensing node to the configuring node, wherein the slope capability information is indicative of one or more frequency slopes with which the sensing node may perform the RF sensing function, and wherein receiving the slope configuration is responsive to the sending of the slope capability information.

Clause 3. The method of any one of clauses 1-2, wherein the one or more parameters include a chirp rate and a scrambling sequence.

Clause 4. The method of clause 3, wherein the scrambling sequence is associated with a scrambling identifier (ID), and wherein the scrambling ID is a function of: a wireless cell of the sensing node, a user equipment (UE) ID of the sensing node, an orthogonal frequency division multiplexing (OFDM) frame number, an OFDM slot index, an OFDM symbol index, or any combination thereof.

Clause 5. The method of one of clauses 1-4, wherein the respective frequency slope value for each chirp of the FMCW transmission sequence is either positive or negative, based on a binary phase-shift keying (BPSK) modulation of the FMCW transmission sequence.

Clause 6. The method of any one of clauses 1-5, wherein the slope configuration is further indicative of a basis FMCW waveform for each chirp of the FMCW transmission sequence, the basis FMCW waveform comprising a saw waveform or a triangular waveform.

Clause 7. The method of clause 6, wherein a basis FMCW waveform of the FMCW transmission sequence comprises a triangular waveform such that: a chirp having a respective positive frequency slope value comprises an FMCW transmission starting at a first initial frequency and including a substantially linear increase in frequency followed by a substantially linear decrease in frequency back to the first initial frequency, and a chirp having a respective negative frequency slope value comprises an FMCW transmission starting at a second initial frequency and including a substantially linear decrease in frequency followed by a substantially linear increase in frequency back to the second initial frequency.

Clause 8. The method of clause 7, wherein the first initial frequency is the same as the second initial frequency, and wherein the chirp having the respective positive frequency slope value and the chirp having the respective negative frequency slope value each use substantially half of a bandwidth allocated for the transmission of the FMCW transmission sequence.

Clause 9. The method of any one of clauses 1-8, wherein the sensing node comprises a transmit (Tx) sensing node, and wherein performing the RF sensing function in accordance with the slope configuration comprises transmitting the FMCW transmission sequence.

Clause 10. The method of any one of clauses 1-9, wherein the sensing node comprises a receive (Rx) sensing node, and wherein performing the RF sensing function in accordance with the slope configuration comprises: receiving the FMCW transmission sequence defined by the one or more parameters included in the slope configuration, and processing the received FMCW transmission sequence to extract a range-Doppler profile.

Clause 11. The method of clause 10, further comprising: detecting, with the Rx sensing node, one or more targets from the range-Doppler profile; and reporting sensing results from the Rx sensing node to the configuring node, the sensing results indicative of the one or more targets.

Clause 12. A method of providing a frequency-modulated continuous wave (FMCW) slope scrambling configuration for radio frequency (RF) sensing, the method comprising: determining, with a configuring node of a wireless network, a slope configuration for a sensing node, wherein the slope configuration includes one or more parameters indicative of a frequency slope value for each chirp of a frequency-modulated continuous wave (FMCW) transmission sequence to be used by the sensing node for RF sensing; and sending the slope configuration to the sensing node to enable the sensing node to perform an RF sensing function in accordance with the slope configuration.

Clause 13. The method of clause 12, further comprising receiving slope capability information at the configuring node from the sensing node, prior to determining the slope configuration, wherein the slope capability information is indicative of one or more frequency slopes with which the sensing node may perform the RF sensing function, and wherein determining the slope configuration is based at least in part on the slope capability information.

Clause 14. The method of any one of clauses 12-13, wherein the one or more parameters include a chirp rate and a scrambling sequence.

Clause 15. The method of clause 14, wherein the scrambling sequence is associated with a scrambling identifier (ID), and wherein the scrambling ID is a function of: a wireless cell of the sensing node, a user equipment (UE) ID of the sensing node, an orthogonal frequency division multiplexing (OFDM) frame number, an OFDM slot index, an OFDM symbol index, or any combination thereof.

Clause 16. The method of any one of clauses 12-15, wherein the sensing node comprises a transmit (Tx) sensing node, a receive (Rx) sensing node, or both.

Clause 17. The method of any one of clauses 12-16, wherein the configuring node comprises a base station or a server of the wireless network.

Clause 18. A sensing node comprising: one or more transceivers; one or more memories; and one or more processors communicatively coupled with the one or more transceivers and the one or more memories, the one or more processors configured to: receive a slope configuration via the one or more transceivers from a configuring node of a wireless network, wherein the slope configuration includes one or more parameters indicative of a frequency slope value for each chirp of a frequency-modulated continuous wave (FMCW)transmission sequence to be used by the sensing node for radio frequency (RF) sensing; and perform an RF sensing function in accordance with the slope configuration.

Clause 19. The sensing node of clause 18, wherein the one or more processors are configured to send slope capability information via the one or more transceivers to the configuring node prior to receiving the slope configuration, wherein the slope capability information is indicative of one or more frequency slopes with which the sensing node may perform the RF sensing function, and wherein the one or more processors are configured to receive the slope configuration responsive to the sending of the slope capability information.

Clause 20. The sensing node of any one of clauses 18-19, wherein the one or more parameters include a chirp rate and a scrambling sequence.

Clause 21. The sensing node of clause 20, wherein the scrambling sequence is associated with a scrambling identifier (ID), and wherein the scrambling ID is a function of: a wireless cell of the sensing node, a user equipment (UE) ID of the sensing node, an orthogonal frequency division multiplexing (OFDM) frame number, an OFDM slot index, an OFDM symbol index, or any combination thereof.

Clause 22. The sensing node of any one of clauses 18-21, wherein the respective frequency slope value for each chirp of the FMCW transmission sequence is either positive or negative, based on a binary phase-shift keying (BPSK) modulation of the FMCW transmission sequence.

Clause 23. The sensing node of any one of clauses 18-22, wherein the sensing node comprises a transmit (Tx) sensing node, and wherein, to perform the RF sensing function in accordance with the slope configuration, the one or more processors are configured to transmit the FMCW transmission sequence via the one or more transceivers.

Clause 24. The sensing node of any one of clauses 18-23, wherein the sensing node comprises a receive (Rx) sensing node, and wherein, to perform the RF sensing function in accordance with the slope configuration, the one or more processors are configured to: receive, via the one or more transceivers, the FMCW transmission sequence defined by the one or more parameters included in the slope configuration, and process the received FMCW transmission sequence to extract a range-Doppler profile.

Clause 25. The sensing node of clause 24, wherein the one or more processors are further configured to: detect one or more targets from the range-Doppler profile; and report sensing results from the Rx sensing node to the configuring node, the sensing results indicative of the one or more targets.

Clause 26. A configuring node comprising: one or more transceivers; one or more memories; and one or more processors communicatively coupled with the one or more transceivers and the one or more memories, the one or more processors configured to: determine a slope configuration for a sensing node, wherein the slope configuration includes one or more parameters indicative of a frequency slope value for each chirp of a frequency-modulated continuous wave (FMCW) transmission sequence to be used by the sensing node for radio frequency (RF) sensing; and send the slope configuration via the one or more transceivers to the sensing node to enable the sensing node to perform an RF sensing function in accordance with the slope configuration.

Clause 27. The configuring node of clause 26, wherein the one or more processors are further configured to receive slope capability information via the one or more transceivers from the sensing node, prior to determining the slope configuration, wherein the slope capability information is indicative of one or more frequency slopes with which the sensing node may perform the RF sensing function, and wherein the one or more processors are configured to determine the slope configuration based at least in part on the slope capability information.

Clause 28. The configuring node of any one of clauses 26-27, wherein the one or more parameters include a chirp rate and a scrambling sequence.

Clause 29. The configuring node of clause 28, wherein the scrambling sequence is associated with a scrambling identifier (ID), and wherein the scrambling ID is a function of: a wireless cell of the sensing node, a user equipment (UE) ID of the sensing node, an orthogonal frequency division multiplexing (OFDM) frame number, an OFDM slot index, an OFDM symbol index, or any combination thereof.

Clause 30. The configuring node of any one of clauses 26-29, wherein the configuring node comprises a base station or a server of a wireless network.

Clause 31. An apparatus having means for performing the method of any one of clauses 1-17.

Clause 32. A non-transitory computer-readable medium storing instructions, the instructions comprising code for performing the method of any one of clauses 1-17.

What is claimed is:

1. A method of frequency-modulated continuous wave (FMCW) slope scrambling at a sensing node for radio frequency (RF) sensing, the method comprising:
receiving a slope configuration at the sensing node from a configuring node of a wireless network, wherein the slope configuration includes one or more parameters indicative of a frequency slope value for each chirp of an FMCW transmission sequence to be used by the sensing node for RF sensing; and
performing an RF sensing function at the sensing node in accordance with the slope configuration.

2. The method of claim 1, further comprising sending slope capability information from the sensing node to the configuring node, wherein the slope capability information is indicative of one or more frequency slopes with which the sensing node may perform the RF sensing function, and wherein receiving the slope configuration is responsive to the sending of the slope capability information.

3. The method of claim 1, wherein the one or more parameters include a chirp rate and a scrambling sequence.

4. The method of claim 3, wherein the scrambling sequence is associated with a scrambling identifier (ID), and wherein the scrambling ID is a function of:
a wireless cell of the sensing node,
a user equipment (UE) ID of the sensing node,
an orthogonal frequency division multiplexing (OFDM) frame number,
an OFDM slot index,
an OFDM symbol index, or
any combination thereof.

5. The method of claim 1, wherein the respective frequency slope value for each chirp of the FMCW transmission sequence is either positive or negative, based on a binary phase-shift keying (BPSK) modulation of the FMCW transmission sequence.

6. The method of claim 1, wherein the slope configuration is further indicative of a basis FMCW waveform for each chirp of the FMCW transmission sequence, the basis FMCW waveform comprising a saw waveform or a triangular waveform.

7. The method of claim 6, wherein a basis FMCW waveform of the FMCW transmission sequence comprises a triangular waveform such that:
a chirp having a respective positive frequency slope value comprises an FMCW transmission starting at a first initial frequency and including a substantially linear increase in frequency followed by a substantially linear decrease in frequency back to the first initial frequency, and
a chirp having a respective negative frequency slope value comprises an FMCW transmission starting at a second initial frequency and including a substantially linear decrease in frequency followed by a substantially linear increase in frequency back to the second initial frequency.

8. The method of claim 7, wherein the first initial frequency is the same as the second initial frequency, and wherein the chirp having the respective positive frequency slope value and the chirp having the respective negative frequency slope value each use substantially half of a bandwidth allocated for the transmission of the FMCW transmission sequence.

9. The method of claim 1, wherein the sensing node comprises a transmit (Tx) sensing node, and wherein performing the RF sensing function in accordance with the slope configuration comprises transmitting the FMCW transmission sequence.

10. The method of claim 1, wherein the sensing node comprises a receive (Rx) sensing node, and wherein performing the RF sensing function in accordance with the slope configuration comprises:
receiving the FMCW transmission sequence defined by the one or more parameters included in the slope configuration, and
processing the received FMCW transmission sequence to extract a range-Doppler profile.

11. The method of claim 10, further comprising:
detecting, with the Rx sensing node, one or more targets from the range-Doppler profile; and
reporting sensing results from the Rx sensing node to the configuring node, the sensing results indicative of the one or more targets.

12. A method of providing a frequency-modulated continuous wave (FMCW) slope scrambling configuration for radio frequency (RF) sensing, the method comprising:
determining, at a configuring node of a wireless network, a slope configuration for a sensing node, wherein the slope configuration includes one or more parameters indicative of a frequency slope value for each chirp of a frequency-modulated continuous wave (FMCW) transmission sequence to be used by the sensing node for RF sensing; and
sending the slope configuration to the sensing node to enable the sensing node to perform an RF sensing function in accordance with the slope configuration.

13. The method of claim 12, further comprising receiving slope capability information at the configuring node from the sensing node, prior to determining the slope configuration, wherein the slope capability information is indicative of one or more frequency slopes with which the sensing node may perform the RF sensing function, and wherein determining the slope configuration is based at least in part on the slope capability information.

14. The method of claim 12, wherein the one or more parameters include a chirp rate and a scrambling sequence.

15. The method of claim 14, wherein the scrambling sequence is associated with a scrambling identifier (ID), and wherein the scrambling ID is a function of:
a wireless cell of the sensing node,
a user equipment (UE) ID of the sensing node,
an orthogonal frequency division multiplexing (OFDM) frame number,
an OFDM slot index,
an OFDM symbol index, or
any combination thereof.

16. The method of claim 12, wherein the sensing node comprises a transmit (Tx) sensing node, a receive (Rx) sensing node, or both.

17. The method of claim 12, wherein the configuring node comprises a base station or a server of the wireless network.

18. A sensing node comprising:
one or more transceivers;
one or more memories; and
one or more processors communicatively coupled with the one or more transceivers and the one or more memories, the one or more processors configured to:
receive a slope configuration via the one or more transceivers from a configuring node of a wireless network, wherein the slope configuration includes one or more parameters indicative of a frequency slope value for each chirp of a frequency-modulated continuous wave (FMCW)transmission sequence to be used by the sensing node for radio frequency (RF) sensing; and
perform an RF sensing function in accordance with the slope configuration.

19. The sensing node of claim 18, wherein the one or more processors are configured to send slope capability information via the one or more transceivers to the configuring node prior to receiving the slope configuration, wherein the slope capability information is indicative of one or more frequency slopes with which the sensing node may perform the RF sensing function, and wherein the one or more processors are configured to receive the slope configuration responsive to the sending of the slope capability information.

20. The sensing node of claim 18, wherein the one or more parameters include a chirp rate and a scrambling sequence.

21. The sensing node of claim 20, wherein the scrambling sequence is associated with a scrambling identifier (ID), and wherein the scrambling ID is a function of:
a wireless cell of the sensing node,
a user equipment (UE) ID of the sensing node,
an orthogonal frequency division multiplexing (OFDM) frame number,
an OFDM slot index,
an OFDM symbol index, or
any combination thereof.

22. The sensing node of claim 18, wherein the respective frequency slope value for each chirp of the FMCW transmission sequence is either positive or negative, based on a binary phase-shift keying (BPSK) modulation of the FMCW transmission sequence.

23. The sensing node of claim 18, wherein the sensing node comprises a transmit (Tx) sensing node, and wherein, to perform the RF sensing function in accordance with the slope configuration, the one or more processors are configured to transmit the FMCW transmission sequence via the one or more transceivers.

24. The sensing node of claim 18, wherein the sensing node comprises a receive (Rx) sensing node, and wherein, to perform the RF sensing function in accordance with the slope configuration, the one or more processors are configured to:
receive, via the one or more transceivers, the FMCW transmission sequence defined by the one or more parameters included in the slope configuration, and
process the received FMCW transmission sequence to extract a range-Doppler profile.

25. The sensing node of claim 24, wherein the one or more processors are further configured to:
detect one or more targets from the range-Doppler profile; and
report sensing results from the Rx sensing node to the configuring node, the sensing results indicative of the one or more targets.

26. A configuring node comprising:
one or more transceivers;
one or more memories; and
one or more processors communicatively coupled with the one or more transceivers and the one or more memories, the one or more processors configured to:
determine a slope configuration for a sensing node, wherein the slope configuration includes one or more parameters indicative of a frequency slope value for each chirp of a frequency-modulated continuous wave (FMCW) transmission sequence to be used by the sensing node for radio frequency (RF) sensing; and
send the slope configuration via the one or more transceivers to the sensing node to enable the sensing node to perform an RF sensing function in accordance with the slope configuration.

27. The configuring node of claim 26, wherein the one or more processors are further configured to receive slope capability information via the one or more transceivers from the sensing node, prior to determining the slope configuration, wherein the slope capability information is indicative of one or more frequency slopes with which the sensing node may perform the RF sensing function, and wherein the one or more processors are configured to determine the slope configuration based at least in part on the slope capability information.

28. The configuring node of claim 26, wherein the one or more parameters include a chirp rate and a scrambling sequence.

29. The configuring node of claim 28, wherein the scrambling sequence is associated with a scrambling identifier (ID), and wherein the scrambling ID is a function of:
a wireless cell of the sensing node,
a user equipment (UE) ID of the sensing node,
an orthogonal frequency division multiplexing (OFDM) frame number,
an OFDM slot index,
an OFDM symbol index, or
any combination thereof.

30. The configuring node of claim 26, wherein the configuring node comprises a base station or a server of a wireless network.
